(19) United States
(12) Patent Application Publication
(10) Pub. No.: US 2018/0115535 A1
(43) Pub. Date: Apr. 26, 2018

(54) Blind En/decryption for Multiple Clients Using a Single Key Pair

(71) Applicant: Netflix, Inc., Los Gatos, CA (US)

(72) Inventor: Manish M. Mehta, San Jose, CA (US)

(21) Appl. No.: 15/333,046

(22) Filed: Oct. 24, 2016

(51) Int. Cl. H04L 29/06; H04L 9/08; H04L 9/30

(52) U.S. Cl. CPC H04L 63/0442; H04L 2209/04; H04L 9/302; H04L 9/0861

(57) ABSTRACT

Different clients encrypt secrets using a server's public RSA key, blind them using randomly generated onetime use blinding factors, and bind them to unique identifiers of corresponding client policies. Encrypted, blinded secrets bound to unique policy ids are transmitted to the server. The server processes different encrypted, blinded secrets received from different clients according to the bound policies. Processing an encrypted blinded secret can involve decrypting it using the corresponding policy id and the server's private key, resulting in a decrypted but still blinded secret which is not readable by the server. The server can then transmit the decrypted blinded secret to one or more clients according to the policy. A client that receives the decrypted blinded secret can unblind and read the secret as plaintext, provided the client has the policy id and the unblinding factor.

### TECHNICAL FIELD

This disclosure pertains generally to cryptography, and more specifically to using blind en/decryption for multiple clients using a single key pair.

### BACKGROUND

Backend servers “in the cloud” can manage the access and distribution of data for a large number of clients within or in association with a given enterprise or service. For example, clients within a given enterprise or other organization can access, edit, share, distribute and otherwise process enterprise data according to specific per client (or group) policies. The clients communicate with the backend server (or collection of servers) across a network, such as the internet or a private wide or local area network. In this context, a given server can provide data management for large numbers of clients (e.g., hundreds, thousands, tens of thousands or more).

The backend server can maintain an asymmetric key pair for encryption/decryption, such as an RSA key pair. The server makes its public key available to the client base to encrypt content, and keeps its private key secret to decrypt such messages. Thus, a given client can encrypt data using the server's public key, and the resulting encrypted data can subsequently be decrypted by the server using its private key. There are various reasons why the client may wish to encrypt data in this manner other than securely sending an encrypted message to the server. For example, the client may wish to encrypt the data to securely provide it to another client, securely store it in a shared location, or maintain it locally in encrypted form for future use. In all such scenarios, the client or target third party cannot decrypt the data itself, but instead requires the server to decrypt the data with its private key. Because the server enforces the data access policies for the clients, the clients could utilize the server's decryption services in this capacity, and the server could coordinate such decryption and distribution for the clients in accordance the relevant policies. However, the server performing the decryption results in the server learning secrets encrypted by the clients, whereas the clients may wish to keep this information private.

This creates several security shortcomings. First, once a client's secret is decrypted by the server, it is known by an additional party, and hence is less secure than if known only to the client (and possibility a targeted third party recipient). Secondly, if the server decrypts a client's secret, the secret necessarily exists in the clear in memory on the server side, where the received encrypted secret is decrypted. Note that the server would be decrypting encrypted content for a large number of clients. No matter how cleverly the code is obfuscated to hide this information, the decrypted secrets would exist in code in the clear on the server, thereby making the server a single target of attack for private data belonging to the client base.

It would be desirable to address these issues.

### SUMMARY

Multiple client computers operate in an organization, and a server computer within the organization makes a public RSA key available to the clients. Different ones of the client computers encrypt secret content using the server's public key. The encrypted secrets cannot be decrypted by the clients, but can be decrypted by the server using its private key. However, the clients wish to keep the encrypted content secret from the server. For this reason, the clients blind the encrypted secrets before transmitting them to the server. Each time a client blinds an encrypted secret, it uses a randomly generated onetime use blinding factor that is compatible with the RSA cryptography in use. This keeps the encrypted secrets private from the server, but still enables the server to decrypt them, into decrypted, blinded form.

It is further desirable for the server to be able to enforce different policies when processing encrypted, blinded secrets received each different clients. Because the server uses a single RSA key pair for cryptographic operations for all clients, the encrypted, blinded messages being received by the server from different clients would not be distinguishable at an encrypted, secured level without an additional factor. In effect, with messages encrypted with a single public key, the server could only enforce a single policy for all clients since nothing in the secure encrypted messages would prove any specific level of access privileges for the originating clients, other than a general one available to anyone in possession of the public key.

For this reason, the clients not only encrypt and blind their secrets, but additionally bind each encrypted, blinded secret to a unique identifier of a corresponding client policy. Because the unique policy id is mathematically bound to the encryption and blinding (and conversely to the decryption and unblinding), clients cannot misrepresent themselves or their access privileges, and the encrypted blinded message is not subject to subsequent tampering. The server can thus securely enforce a separate policy for each client or group of clients, as if each client or group had its own unique encryption key, but without the prohibitive overhead of generating, maintaining, distributing and utilizing separate keys for each member of or group within the large client base within the organization.

The server can thus process different encrypted, blinded secrets received from different clients according to the separate policies associated with the corresponding unique policy ids to which the different encrypted, blinded secrets are bound. Processing an encrypted blinded secret can involve decrypting it using the corresponding policy id and the server's private key, resulting in a decrypted but still blinded secret which is not readable by the server. The server can then transmit the decrypted blinded secret to one or more clients according to the policy. A client that receives the decrypted blinded secret can unblind and read the secret as plaintext, provided the client has the policy id and the unblinding factor corresponding to the onetime use blinding factor that was used to blind the secret in the first place.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram of an exemplary network architecture in which a blind en/decryption system can be implemented, according to some embodiments.

FIG. 2 is a block diagram of the operation of a blind en/decryption system, according to some embodiments.

FIG. 3 is a flow chart illustrating client side steps for the operation of a blind en/decryption system, according to some embodiments.

FIG. 4 is a flow chart illustrating server side steps for the operation of a blind en/decryption system, according to some embodiments.

FIG. 5 is a block diagram of a computer system suitable for implementing a blind en/decryption system, according to some embodiments.

The Figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

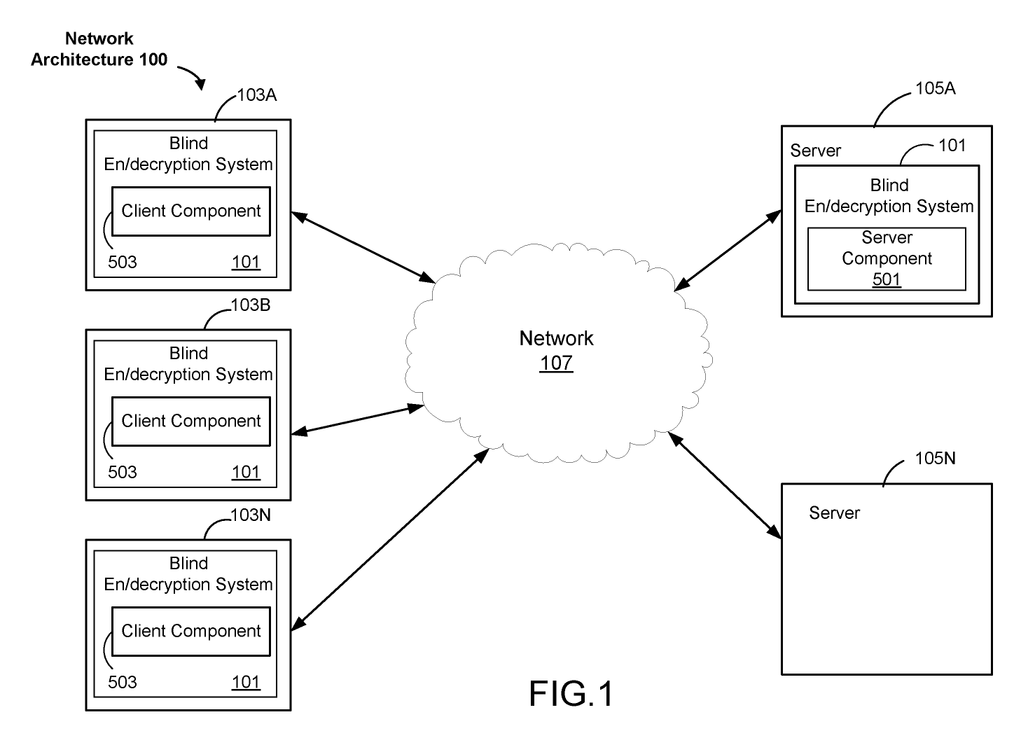

FIG. 1 is a block diagram illustrating an exemplary network architecture 100 in which a blind en/decryption system 101 can be implemented. The illustrated network architecture 100 comprises multiple clients 103A, 103B and 103N, as well as multiple servers 105A and 105N. In FIG. 1, a server component 501 of the blind encryption system 101 is illustrated as residing on server 105A, and a separate client component 503 of the blind encryption system 101 is illustrated as residing on each client 103A-N. It is to be understood that this is an example only, and in various embodiments various functionalities of this system 101 can be instantiated on a client 103, a server 105, or can be distributed between multiple clients 103 and/or servers 105.

Although FIG. 1 illustrates three clients 103 and two servers 105 as an example, in practice many more (or fewer) clients 103 and/or servers 105 can be deployed. In one embodiment, network 107 is in the form of a private enterprise level wide area network, although other networks (e.g., the internet,) can be used in other embodiments.

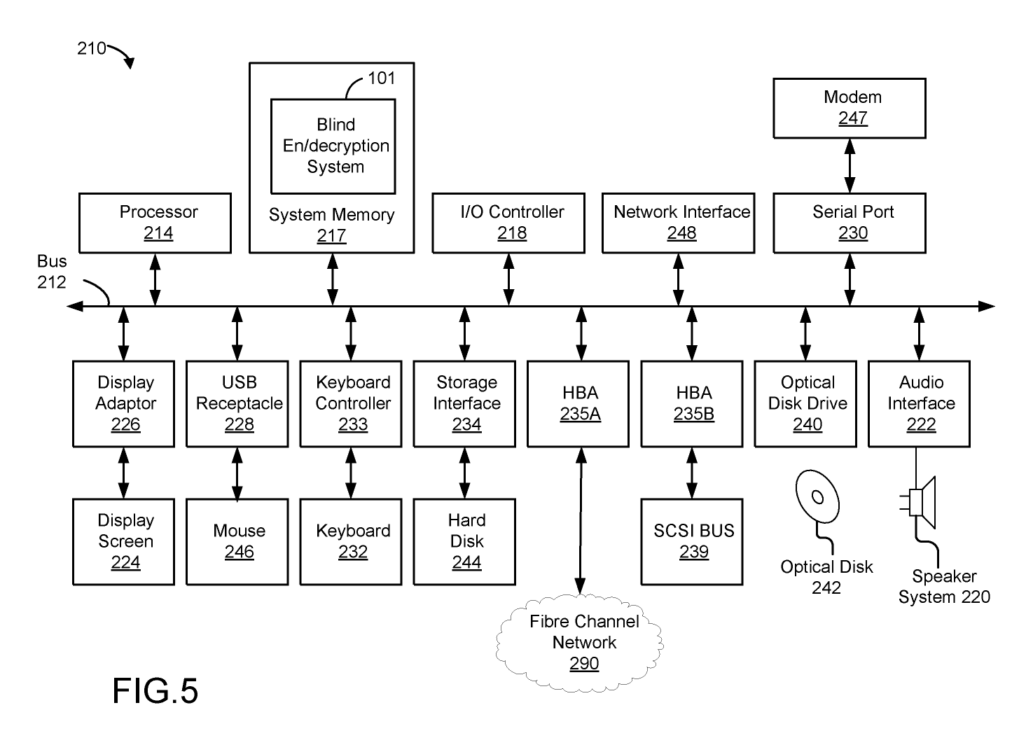

Clients 103 and servers 105 can be implemented using computer systems 210 such as the one illustrated in FIG. 5 and described below. The clients 103 and servers 105 are communicatively coupled to the network 107, for example via a network interface 248 or modem 247 as described below in conjunction with FIG. 5. Clients 103 are able to access applications and/or data on servers 105 using, for example, a web browser or other client software (not shown). Clients 103 can be in the form of desktop computers, laptop computers, or mobile computing devices, comprising portable computer systems capable of connecting to a network 107 and running applications. Such mobile computing devices are sometimes referred to as smartphones, although some mobile phones not so designated also have these capabilities. Tablets and wearable computing devices (e.g., smart watches, bracelets, glasses, etc.) are other examples of mobile computing devices.

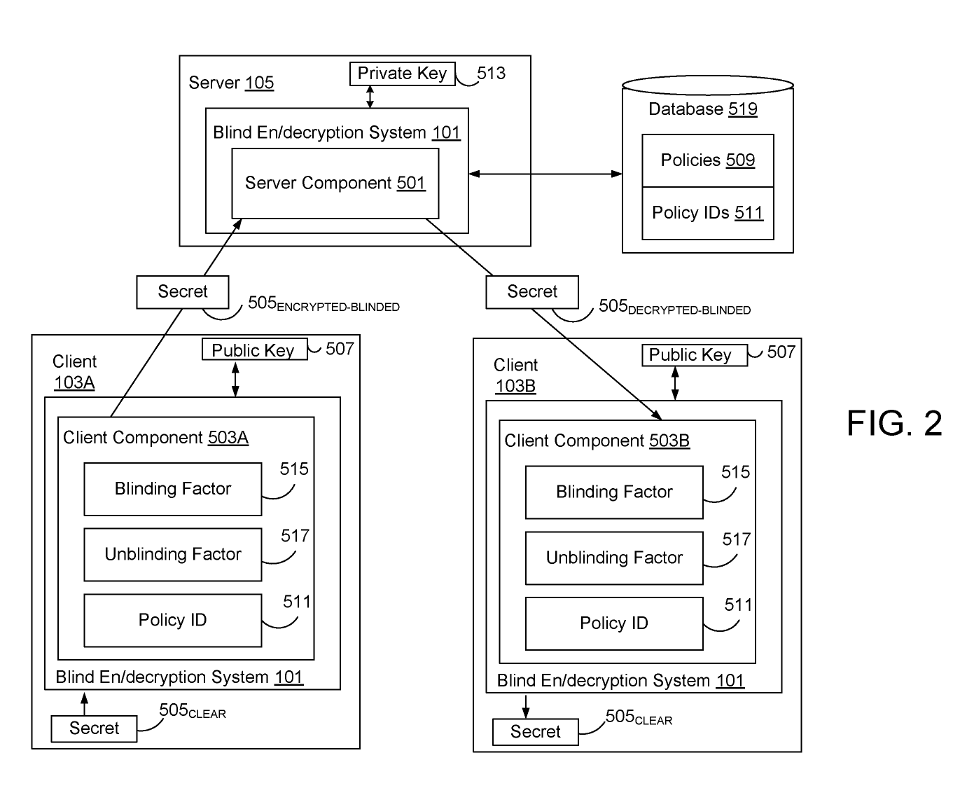

FIG. 2 illustrates the operation of a blind en/decryption system 101, according to some embodiments. In FIG. 2, the blind en/decryption system 101 is illustrated as comprising a server component 501 residing on a server 105 and separate client components 503 residing on a first client 103A and on a second client 103B. As described above, the functionalities of the blind en/decryption system 101 can reside on a client 103, a server 105, or be distributed between multiple computer systems 210. It is to be understood that although the server component 501 and client components 503 of the blind en/decryption system 101 are both illustrated in FIGS. 2 as single entities, the blind en/decryption system 101 represent a collection of functionalities, which can be instantiated as a single or multiple modules as desired. In some embodiments, the different modules of the blind en/decryption system 101 can reside on different computing devices 210 as desired. It is to be understood that the modules of the blind en/decryption system 101 can be instantiated (for example as object code or executable images) within the system memory 217 (e.g., RAM, ROM, flash memory) of any computer system 210, such that when the processor 214 of the computer system 210 processes a module, the computer system 210 executes the associated functionality. As used herein, the terms “computer system,” “computer,” “client,” “client computer,” “server,” “server computer” and “computing device” mean one or more computers configured and/or programmed to execute the described functionality. Additionally, program code to implement the functionalities of the blind en/decryption system 101 can be stored on computer-readable storage media. Any form of tangible computer readable storage medium can be used in this context, such as magnetic or optical storage media. As used herein, the term “computer readable storage medium” does not mean an electrical signal separate from an underlying physical medium.

As illustrated in FIG. 2, a server component 501 of the blind en/decryption system 101 runs on a server 105, a client component 503A of the blind en/decryption system 101 runs on the first client 103A, and a separate client component 503B runs on the second client 103B. Although only two clients 103 are illustrated and described in conjunction with FIG. 2, it is to be understood that a single server component 501 of the blind en/decryption system 101 can interact with orders of magnitude more separate client components 503 residing on a large number of clients 103.

Suppose the first client 103A maintains a secret 505 (e.g., private data), which it would like to securely provide to the second client 103B. The first client 103A lacks a secure channel to the second client other than the use of the server's supported cryptography services. More specifically, the server 105 supports secure asymmetric cryptography using RSA, and makes its public key 507 available to the clients 103. Hence, the client component 503A on the first client 103A could encrypt the secret 505 using the server's public key 507 and transmit the encrypted secret 505_{ENCRYPTED} to the second client 103B.

To carry out these steps, the client component 503A on the first client 103A could encrypt the secret 505 using the public key 507 as follows:

M=S^{e} mod N

Where:

M=the secret encrypted with server's public key

S=the secret in the clear;

e=the RSA public exponent; and

N=the RSA modulus.

Put another way, the secret S is encrypted using the server's public key e as M=E_{key}(S), where Eₑ(X) is the encryption function.

M, the encrypted secret 505, could now be provided to the second client 103B by the first client 103A. The encrypted secret 505_{ENCRYPTED} would need to be decrypted by the server 105 in order for the second client 103B to be able to read it. However, if the server 105 were to perform such decryption, the server 105 would learn a client's secret 505 each time it performed such an operation, thereby compromising client privacy directly, as well as becoming a single target of attack for malicious parties attempting to misappropriate secrets 505 from the client base.

It is to be understood that secure transmission of a secret 505 from the first to the second client 103 is only one example of a scenario in which it is desirable for clients to avail themselves of the server's support of RSA and the corresponding server side decryption, without the server 105 learning the secret(s) 505 at issue. For example, as noted above, a client 103 may wish to securely store an encrypted secret 505_{ENCRYPTED} locally or remotely, such that it can be accessed by one or more given target parties under specific circumstances. In another example scenario, a client 103 could encrypt and store a secret 505 ENCRYPTED, ENCRYPTED and later the same client 103 could wish to have the server 105 decrypt the secret 505 without being able to learn its content.

Back to the current scenario, recall that in this example embodiment the second client 103B received the encrypted secret 505ENCRYPTED from the first client 103A. The second client 103B could then transmit the encrypted secret 505_{ENCRYPTED} (M) to the server 105 to decrypt using the private key 513, but as noted above if that were done then the server 105 would have the secret 505 in the clear. In order to avail itself of the server's decryption services without the server 105 learning the secret 505, the client components 503 and server component 501 of the blind en/decryption system 101 can utilize blinding, as described in detail below.

In cryptography, blinding is a technique by which one party (in this case the server 105) can compute a function (in this case decryption) for another party (in this case the clients 105), in an encoded form without knowing either the actual input or output. Here, the client 105 has an input M which it would like the server 105 to decrypt on its behalf, because the client 103 does not have the server's private key 513 which is required to decrypt M. However, as discussed above, the client 103 does not wish for the server to learn S, and hence the server 105 cannot know M either. Put another way, the client 103 wants the server to computer S=D_{d}(M) without revealing either M or S (the input and output of the decryption function D( ) ) to the server 105. To achiev this, the client 103 blinds the input by encoding it according too a function that is mathematically compatible with the cryptographic functions, such that a message can. be encrypted, blinded, decrypted, and unblinded without losing integrity. in other words, when the encrypted, blinded text is decrypted, the result is a decrypted message that is still blinded, cannot be discerned without being unblinded, but after being unblinded is the original message in the clear.

For example, if Alice has a secret message S she wishes to securely share with Bob, but needs Oscar to decrypt the message without reading it, she could blind the encrypted secret M as B(M)=Z, where B( ) is the blinding function. Alice then sends Z to Oscar, who does not learn. M since it is encoded by the blinding function. Oscar decrypts the blinded encrypted message Z as D (Z)=Φ, where Φ is the decrypted but still blinded message. Oscar thus does not learn S, because Oscar is only exposed to the decrypted message in blinded form. Oscar provides Φ to Bob, who shares Alice's unblinding function U( ) Consequently, Bob is able to unblind Φ resulting in the original S.

The blinding function utilizes a blinding factor R. In order for the blinding and unblinding to work in conjuntion with the encryption and. decryption, where f(x) is the cryptographic function performed by Oscar, the blinding (encoding) factor R must be a bijection on the input space of f. The security is most robust where R is further a. random permutation. Oscar returns f(B(x) to which Bob applies the unblinding function U( ) to obtain U(f(B(x)))=S. Not all functions allow for blind computation, but RSA cryptography does.

More specifically, in RSA blinding involves computing the blinding operation B(x)=(xR)=mod N=Z, where R (the blinding factor) is a random integer between and 1 N and relatively prime to N (i.e., gcd(r, N)=1) where gcd is the greatest common denominator, x is the plaintext, e is the public RSA exponent, N is the RSA modulus and Z is the encrypted, blinded text. To decrypt Z, the RSA decryption function D(Z)=Z^{d} mod N is applied, giving D(B(x))=(xR)^{ed} mod N=xR mod N=Φ, where d is the private RSA exponent and Φ is the decrypted, blinded text. Φ can be unblind using the unblindinq function U(Φ)=ΦR⁻¹ mod N. Multiplying xR mod N by R⁻¹ mod N yields x (the plantext), as desired.

Thus, in the example embodiment currently being described, the second client 103B receives the encrypted secret 505_{ENCRYPTED} from the first client 103A. The second client component 503B then blinds the encrypted secret 505_{ENCRYPTED} before providing it to the server 105 for decryption. Because the secret 505 is blinded, the server 105 is not able to learn the secret 505, even after decrypting it. Note that the specific blinding factor 515 used by the client component 503 is calculated on the fly at run time and only used once. More specifically, when blinding the encrypted secret 505_{ENCRYPTED}, a client component 503 uses a suitable random permutation as the blinding factor 515. Since the client component 503 creates a onetime use blinding factor 515 (R) on the fly during each blinding operation, each specific value used for R is ephemeral. This provides a high level of security. In effect, the blinding operation places the encrypted secret 505_{ENCRYPTED} into a secure box.

However, blinding encrypted client secrets 505_{ENCRYPTED} is still not be enough for the server 105 to distinguish between clients 103 securely. Recall that the server 105 is communicating with a large number of separate clients 103 within an organization. Each client 103 under the server's jurisdiction (e.g., each client 103 within the given enterprise) is governed by the server 105 according a given policy 509. Policies 509 specify terms according to which different clients 103 can access various resources within the organization, such as data, services, other clients 103, etc. Each policy 509 is associated with a unique policy id 511. The specific format of the policy ids 511 can vary between embodiments. For example, unique numbers or alphanumeric strings can be used as policy ids 511. As such it is desirable for the server 105 to be able to treat each client 103 differently, and enforce separate corresponding policies 509 accordingly. The server 105 has access to the multiple policies 509 governing the various clients 103, which can be stored, for example, in a database 519 or other suitable storage mechanism, or which could be maintained by a separate policy sever (not illustrated).

Because only a single RSA key pair is being used across the entire client base, the encrypted, blinded messages being received by the server 105 from the plurality of clients 103 would not be distinguishable at an encrypted, secured level absent more than the encryption and blinding described above. In effect, with messages encrypted with a single public key e, the server 105 could only enforce a single policy 509 for all clients 103. Otherwise, transmitting parties could claim certain access privileges they do not have, and nothing in the secure encrypted messages would prove any specific level of access other than a general one available to all clients in possession of e, which is public.

For this reason, a client component 503 not only encrypts and blinds the secret 505, but additionally binds the encrypted, blinded to the client's policy id 511. Where the blinding puts the encrypted secret 505_{ENCRYPTED} in a secure box, binding the secure box to the policy id 511 enables the server 105 is to enforce the specific policy 509 for the given client 103. Because the policy id 511 is mathematically bound to the encryption and blinding (and conversely to the decryption and unblinding), clients 103 cannot misrepresent themselves or their access privileges, and the encrypted blinded message is not subject to subsequent tampering. The server 105 can thus enforce a separate policy 509 for each client 103 and/or group of clients 103, as if each client 103 (or group) had its own encryption key, but without the prohibitive overhead, logistical difficulty, and computational cost of generating, maintaining, distributing and utilizing separate keys for each member of the large client base within the organization.

In order to provide a blinded, encrypted secret bound to a given policy id 511 to the server 105, the second client component 503B can generate Zₚ (the blinded encrypted message Z bound to policy id p) as follows:

Zₚ=M*R^{ep} mod N, (which is equivalent to S^{ep}R^{ep} mod N)

Where:

M=the encrypted secret

R=the blinding factor

e=the RSA public exponent;

p=the policy id to bind to Z

N=the RSA modulus; and

S=the secret in the clear;

The second client component 503B transmits Zₚ, the blinded, encrypted secret bound to the policy id, to the server component 501. The server component 501 can now decrypt and further process Zₚ according to the terms of the specific policy 509 identified by the given policy id 511. In order to decrypt Zₚ, the server component utilizes its private key 513 as well as the policy id 511, resulting in the unencrypted but still blinded secret. Thus, the server 105 does not access the secret in the clear, nor does the plaintext exist in code or memory on the server side at any point. At the same time, the server 105 is able to utilize a single RSA key pair, yet securely identify and distinguish between separate clients, and enforce separate corresponding polices 509 as discussed in greater detail below.

To decrypt Zₚ the server component calculates:

Φ=(Zₚ)^{d}^{ₚ} mod N

Where:

Φ=the decrypted, blinded secret

d=the RSA private exponent

p=the policy id;

dₚ=(ep)⁻¹ mod N where e=the RSA public exponent

Zₚ=the blinded encrypted message bound to the policy id (equivalent to S^{ep}R^{ep} mod N as shown above); and

N=the RSA modulus

Recall that in the current example the second client component 503B has requested that the server component 105 return the decrypted but still blinded secret Φ to the second client 103B. In this example, the server 105 proceeds to do so if and only if the policy 509 in question permits this. Where this is the case, the server component transmits Φ to the client component 503B on the second client 103B, which blinded the encrypted secret and thus also has the unblinding factor 517. As explained above, the unblinding factor 517 for a given value of R is equal to R⁻¹ (the modular multiplicative inverse of R). Because the second client component 503B has the unblinding factor 517, it can perform the unblinding of Φ resulting in the secret S in the clear as:

S=ΦR⁻¹ mod N

In this example, the first client 103A has securely provided the secret S to the second client 103B utilizing the decryption services of the server 105, without the server 105 learning S. Note further that had the given policy 509 not authorized the second client 103B to decrypt this content, the server component 501 could decline to perform the decryption and/or transmission to the second client 103B, and could optionally take any additional actions desired in response to the attempted policy violation, such as display an alert, send a warning to an administrator, etc.

It is to be understood that the secure transmission of a secret 505 between clients 103 using the server's decryption function is only one example of an instance in which client(s) 103 can beneficially utilize the server's decryption function without the server 105 learning the secret(s) 505. The above-described requested decryption of a blinded secret 505 is also only a single example of such an activity that can be performed or blocked by the server 105 in conjunction with enforcement of a corresponding policy 509. Many other examples will be apparent to those of ordinary skill in the relevant art in light of this specification, such as sharing specific data with a group, storing data in a given folder accessible to specific parties, etc.

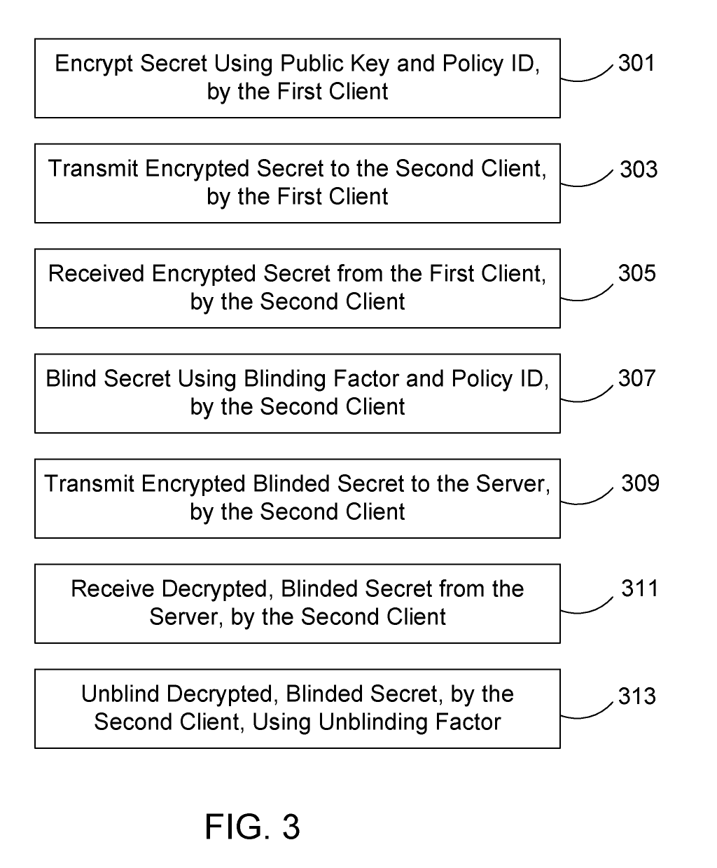

FIG. 3 shows client side steps performed during the course of the operation of the blind en/decryption system 101 according to the above-described example. The first client component 503A encrypts 301 a secret 505, using the server's public key 507 and the policy id 511 of the relevant policy 509. The first client component 503A then transmits 303 the encrypted secret 505_{ENCRYPTED} to the second client component 503B. The second client component 503B receives 305 the encrypted secret 505_{ENCRYPTED} from the first client component 503A, and proceeds to blind 307 the encrypted secret 505_{ENCRYPTED} using the blinding factor 515 and the policy id 511. The second client component 503B then transmits 309 the encrypted, blinded secret 305_{ENCRYPTED-BLINDED} to the server component 501. The second client component 503B receives 311 the decrypted, blinded secret 305_{DECRYPTED-BLINDED} from the server component 501. The second client component 503B then unblinds 313 the decrypted, blinded secret 305_{DECRYPTED-BLINDED} using the unblinding factor 517, resulting in the secret 305 in plaintext.

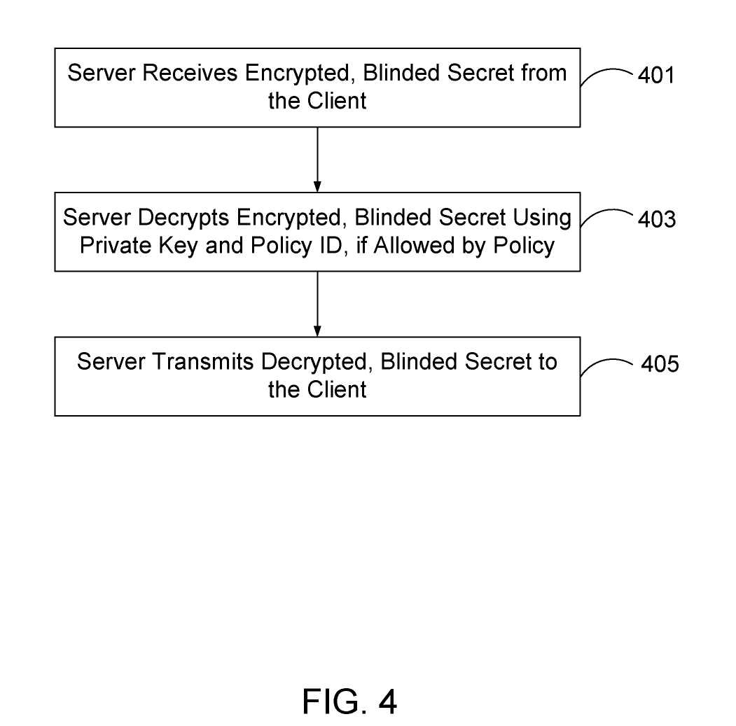

FIG. 4 shows server side steps performed during the course of the operation of the blind en/decryption system 101 according to one embodiment. The server component 501 receives 401 the encrypted, blinded secret 305_{ENCRYPTED-BLINDED} from the client component 503. The server component decrypts 403 the encrypted, blinded secret 305_{ENCRYPTED-BLINDED} using the server's private key 513 and the policy id 511, if and only if this is allowed under the given policy 509. Policy permitting, the server component then transmits 405 the decrypted, blinded secret 305_{DECRYPTED-BLINDED} to the client component 503.

FIG. 5 is a block diagram of a computer system 210 suitable for implementing a blind en/decryption system 101. Both clients 103 and servers 105 can be implemented in the form of such computer systems 210. As illustrated, one component of the computer system 210 is a bus 212. The bus 212 communicatively couples other components of the computer system 210, such as at least one processor 214, system memory 217 (e.g., random access memory (RAM), read-only memory (ROM), flash memory), an input/output (I/O) controller 218, an audio output interface 222 communicatively coupled to an audio output device such as a speaker 220, a display adapter 226 communicatively coupled to a video output device such as a display screen 224, one or more interfaces such as Universal Serial Bus (USB) receptacles 228, serial ports 230, parallel ports (not illustrated), etc., a keyboard controller 233 communicatively coupled to a keyboard 232, a storage interface 234 communicatively coupled to one or more hard disk(s) 244 (or other form(s) of storage media), a host bus adapter (HBA) interface card 235A configured to connect with a Fibre Channel (FC) network 290, an HBA interface card 235B configured to connect to a SCSI bus 239, an optical disk drive 240 configured to receive an optical disk 242, a mouse 246 (or other pointing device) coupled to the bus 212, e.g., via a USB receptacle 228, a modem 247 coupled to bus 212, e.g., via a serial port 230, and one or more wired and/or wireless network interface(s) 248 coupled, e.g., directly to bus 212.

Other components (not illustrated) may be connected in a similar manner (e.g., document scanners, digital cameras, printers, etc.). Conversely, all of the components illustrated in FIG. 5 need not be present (e.g., smartphones and tablets typically do not have optical disk drives 240, external keyboards 242 or external pointing devices 246, although various external components can be coupled to mobile computing devices via, e.g., USB receptacles 228). The various components can be interconnected in different ways from that shown in FIG. 5.

The bus 212 allows data communication between the processor 214 and system memory 217, which, as noted above may include ROM and/or flash memory as well as RAM. The RAM is typically the main memory into which the operating system and application programs are loaded. The ROM and/or flash memory can contain, among other code, the Basic Input-Output system (BIOS) which controls certain basic hardware operations. Application programs can be stored on a local computer readable medium (e.g., hard disk 244, optical disk 242) and loaded into system memory 217 and executed by the processor 214. Application programs can also be loaded into system memory 217 from a remote location (i.e., a remotely located computer system 210), for example via the network interface 248 or modem 247. In FIG. 5, the blind en/decryption system 101 is illustrated as residing in system memory 217.

The storage interface 234 is coupled to one or more hard disks 244 (and/or other standard storage media). The hard disk(s) 244 may be a part of computer system 210, or may be physically separate and accessed through other interface systems.

The network interface 248 and/or modem 247 can be directly or indirectly communicatively coupled to a network 107 such as the internet. Such coupling can be wired or wireless.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies, data structures and other aspects are not mandatory or significant, and the mechanisms that implement the invention or its features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated.

Aspects of the subject matter described herein are set out in the following numbered clauses:

1. A computer implemented method comprising: computationally generating, by a specific client computer, a onetime use blinding factor, wherein the onetime use blinding factor is a randomly selected member of a set of blinding factors compatible for blinding values encrypted using a public key of a server computer; blinding an encrypted secret, by the specific client computer, using the onetime use blinding factor and a unique policy id corresponding to a specific policy governing at least one client computer, resulting in an encrypted, blinded secret bound to the unique policy id, wherein the private key of the server computer and the unique policy id can be used to decrypt but not to unblind the encrypted blinded secret; and transmitting the encrypted blinded secret by the specific client computer to the server computer, resulting in the server computer processing the encrypted blinded secret according to the specific policy corresponding to the unique policy id to which the encrypted blinded secret is bound.

2. The method of clause 1 wherein computationally generating, by the specific client computer, a onetime use blinding factor further comprises: generating a value that is -ion on the input space of a decryption function used by the server computer for decrypting values encrypted using the public key of the server computer, the generated value further comprising a random permutation.

3. The method of clause 1 wherein encryption and decryption are performed using RSA, and wherein computationally generating, by the specific client computer, a onetime use blinding factor further comprises: selecting a random integer between 1 and RSA modulus N and relatively prime to RSA modulus N.

4. The method of clause 1 further comprising: encrypting the secret, by the specific client computer, using the public key of the server computer and the unique policy id, wherein the unique policy id corresponds to a specific policy governing the specific client computer.

5. The method of clause 4 wherein encrypting the secret using the public key of the server computer and the unique policy id further comprises: encrypting the secret using an RSA encryption function, with an RSA public exponent, the unique policy id and an RSA modulus as parameters.

6. The method of clause 5 further comprising: encrypting and blinding the secret by applying S^{ep}R^{ep} mod N, where S is the secret, e is the RSA public exponent, p is the unique policy id, R is the onetime use blinding factor and N is the RSA modulus, resulting in the encrypted blinded secret bound to the unique policy.

7. The method of clause 1 further comprising: receiving the encrypted secret, by the specific client computer, from a separate client computer, the separate client computer having encrypted the secret using the public key of the server computer and the unique policy id.

8. The method of clause 1 wherein the server computer processing the encrypted blinded secret according to the specific policy corresponding to the unique policy id to which the encrypted blinded secret is bound further comprises: the server computer decrypting the encrypted blinded secret using a private key of the server computer and the unique policy id, resulting in a decrypted blinded secret bound to the unique policy id, wherein the decrypted blinded secret is not discernable to the server computer; and transmitting the decrypted blinded secret bound to the unique policy id by the server computer to the specific client computer.

9. The method of clause 1 further comprising: receiving, by the specific client computer from the server computer, the secret decrypted but still blinded and bound to the unique policy id; and unblinding the decrypted blinded secret bound to the unique policy id, by the specific client computer, using the unique policy id and an unblinding factor corresponding to the onetime use blinding factor, resulting in the secret in plaintext.

10. The method of clause 9 wherein: the unblinding factor corresponding to the onetime use blinding factor further comprises the modular multiplicative inverse of the blinding factor.

11. The method of clause 9 wherein unblinding the decrypted blinded secret bound to the unique policy id using the unique policy id and an unblinding factor corresponding to the onetime use blinding factor further comprises: unblinding the decrypted blinded secret bound to the unique policy id by applying S=ΦR⁻¹ mod N, where Φ is the decrypted blinded secret bound to the policy id, R⁻¹ is the modular multiplicative inverse of the blinding factor, N is a corresponding RSA modulus and S is the secret in plaintext.

12. The method of clause 1 further comprising: blinding multiple separate encrypted secrets, by the specific client computer; and for each separate encrypted secret blinded by the specific client computer, generating a separate onetime use blinding factor, and using a separate generated onetime use blinding factor to blind each separate encrypted secret.

13. A computer implemented method comprising: receiving, by a server computer from a client computer, an encrypted blinded secret bound to a unique policy id corresponding to a specific policy governing the client computer, the encrypted blinded secret having been encrypted using a public key of the server computer and the unique policy id, and having been blinded by the client computer using a onetime use blinding factor and the unique policy id; decrypting the encrypted blinded secret, by the server computer, using a private key of the server computer and the unique policy id, resulting in a decrypted blinded secret bound to the unique policy id, wherein the decrypted blinded secret is not discernable to the server computer; and further processing the decrypted blinded secret, by the server computer, according to the specific policy corresponding to the unique policy id to which the encrypted blinded secret is bound.

14. The method of clause 13 wherein decrypting the encrypted blinded secret using a private key of the server computer and the unique policy id further comprises: decrypting the encrypted blinded secret using an RSA decryption function, with an RSA private exponent, the unique policy id and an RSA modulus as parameters.

15. The method of clause 14 further comprising: decrypting the encrypted blinded secret by applying (Zₚ)^{d}^{ₚ} mod N, where Zₚ is the blinded, encrypted secret bound to the unique policy id, d is the RSA private exponent, p is the unique policy id, dₚ−(ep)⁻¹ mod N where e=the RSA public exponent and N is the RSA modulus, resulting in the decrypted blinded secret bound to the unique policy id.

16. The method of clause 13 wherein further processing the decrypted blinded secret according to the specific policy corresponding to the unique policy id to which the encrypted blinded secret is bound further comprises: transmitting the decrypted blinded secret bound to the unique policy id, by the server computer to the client computer.

17. A computer implemented method comprising: receiving separate encrypted blinded secrets, by a server computer from a plurality of client computers, each separate received encrypted blinded secret being bound to a separate unique policy id, each separate unique policy id corresponding to a specific policy governing a given specific client computer from which a bound encrypted blinded secret was received; and processing each separate specific received encrypted blinded secret, by the server computer, according to a specific policy corresponding to a specific unique policy id to which the specific encrypted blinded secret is bound; wherein the server computer processes different separate specific received encrypted blinded secrets differently, according to separate specific policies.

18. The method of clause 17 wherein processing different separate specific received encrypted blinded secrets differently further comprises: decrypting at least a subset of the separate specific received encrypted blinded secrets, by the server computer; wherein decrypting a specific received encrypted blinded secret further comprises using a private key of the server computer and a unique policy id to which the specific received encrypted blinded secret is bound, resulting in a specific decrypted blinded secret bound to the specific unique policy id which is not discernable to the server computer.

19. The method of clause 18 further comprising: transmitting different specific decrypted blinded secrets bound to different specific unique policy ids to different ones of the plurality of client computers, resulting in different ones of the plurality of client computers unblinding received decrypted blinded secrets using unique policy ids to which the received decrypted blinded secrets are bound and unblinding factors corresponding specific onetime use blinding factors, resulting in corresponding secrets in plaintext.

20. The method of clause 18 wherein decrypting a specific encrypted blinded secret using a private key of the server computer and a specific unique policy id further comprises: decrypting the specific encrypted blinded secret using an RSA decryption function, with an RSA private exponent, the specific unique policy id and an RSA modulus as parameters.

What is claimed is:

1. A computer implemented method comprising:
computationally generating, by a specific client computer, a onetime use blinding factor, wherein the onetime use blinding factor is a randomly selected member of a set of blinding factors compatible for blinding values encrypted using a public key of a server computer;
blinding an encrypted secret, by the specific client computer, using the onetime use blinding factor and a unique policy id corresponding to a specific policy governing at least one client computer, resulting in an encrypted, blinded secret bound to the unique policy id, wherein the private key of the server computer and the unique policy id can be used to decrypt but not to unblind the encrypted blinded secret; and
transmitting the encrypted blinded secret by the specific client computer to the server computer, resulting in the server computer processing the encrypted blinded secret according to the specific policy corresponding to the unique policy id to which the encrypted blinded secret is bound.

2. The method of claim 1 wherein computationally generating, by the specific client computer, a onetime use blinding factor further comprises:
generating a value that is bijection on the input space of decryption function used by the server computer for decrypting values encrypted using the public key of the server computer, the generated value further comprising a random permutation.

3. The method of claim 1 wherein encryption and decryption are performed using RSA, and wherein computationally generating, by the specific client computer, a onetime use blinding factor further comprises:
selecting a random integer between and RSA modulus N and relativevely prime to RSA modulus N.

4. The method of claim 1 further comprising:
encrypting the secret, by the specific client computer, using the public key of the server computer and the unique policy id, wherein the unique policy id corresponds to a specific policy governing the specific client computer.

5. The method of claim 4 wherein encrypting the secret using the public key of the server computer and the unique policy id further comprises:
encrypting the secret using an RSA encryption function, with an RSA public exponent, the unique policy id and an RSA modulus as parameters.

6. The method of claim 5 further comprising:
encrypting and blinding the secret by applying S^{ep}R^{ep} mod N, where S is the secret, e is the RSA public exponent, p is the unique policy id, R is the onetime use blinding factor and N is the RSA modulus, resulting in the encrypted blinded secret bound to the unique policy.

7. The method of claim 1 further comprising:
receiving the encrypted secret, by the specific client computer, from a separate client computer, the separate client computer having encrypted the secret using the public key of the server computer and the unique policy id.

8. The method of claim 1 wherein the server computer processing the encrypted blinded secret according to the specific policy corresponding to the unique policy id to which the encrypted blinded secret is bound further comprises:
the server computer decrypting the encrypted blinded secret using a private key of the server computer and the unique policy id, resulting in a decrypted blinded secret bound to the unique policy id, wherein the decrypted blinded secret is not discernable to the server computer; and
transmitting the decrypted blinded secret bound to the unique policy id by the server computer to the specific client computer.

9. The method of claim 1 further comprising:
receiving, by the specific client computer from the server computer, the secret decrypted but still blinded and bound to the unique policy id; and
unblinding the decrypted blinded secret bound to the unique policy id, by the specific client computer, using the unique policy id and an unblinding factor corresponding to the onetime use blinding factor, resulting in the secret in plaintext.

10. The method of claim 9 wherein:
the unblinding factor corresponding to the onetime use blinding factor further comprises the modular multiplicative inverse of the blinding factor.

11. The method of claim 9 wherein unblinding the decrypted blinded secret bound to the unique policy id using the unique policy id and an unblinding factor corresponding to the onetime use blinding factor further comprises:
unblinding the decrypted blinded secret bound to the unique policy id by applying S=ΦR⁻¹ mod N, where Φ is the decrypted blinded secret bound to the policy id, R⁻¹ is the modular multiplicative inverse of the blinding factor, N is a corresponding RSA modulus and S is the secret in plaintext.

12. The method of claim 1 further comprising:
blinding multiple separate encrypted secrets, by the specific client computer; and
for each separate encrypted secret blinded by the specific client computer, generating a separate onetime use blinding factor, and using a separate generated onetime use blinding factor to blind each separate encrypted secret.

13. A computer implemented method comprising:
receiving, by a server computer from a client computer, an encrypted blinded secret bound to a unique policy id corresponding to a specific policy governing the client computer, the encrypted blinded secret having been encrypted using a public key of the server computer and the unique policy id, and having been blinded by the client computer using a onetime use blinding factor and the unique policy id;
decrypting the encrypted blinded secret, by the server computer, using a private key of the server computer and the unique policy id, resulting in a decrypted blinded secret bound to the unique policy id, wherein the decrypted blinded secret is not discernable to the server computer; and
further processing the decrypted blinded secret, by the server computer, according to the specific policy corresponding to the unique policy id to which the encrypted blinded secret is bound.

14. The method of claim 13 wherein decrypting the encrypted blinded secret using a private key of the server computer and the unique policy id further comprises:
decrypting the encrypted blinded secret using an RSA decryption function, with an RSA private exponent, the unique policy id and an RSA modulus as parameters.

15. The method of claim 14 further comprising:
decrypting the encrypted blinded secret by applying (Zₚ)^{d}^{ₚ} mod N, where Zₚ is the blinded, encrypted secret bound to the unique policy id, d is the RSA private exponent, p is the unique policy id, dₚ=(ep)⁻¹ mod N where e=the RSA public exponent and N is the RSA modulus, resulting in the decrypted blinded secret bound to the unique policy id.

16. The method of claim 13 wherein further processing the decrypted blinded secret according to the specific policy corresponding to the unique policy id to which the encrypted blinded secret is bound further comprises:
transmitting the decrypted blinded secret bound to the unique policy id, by the server computer to the client computer.

17. A computer implemented method comprising:
receiving separate encrypted blinded secrets, by a server computer from a plurality of client computers, each separate received encrypted blinded secret being bound to a separate unique policy id, each separate unique policy id corresponding to a specific policy governing a given specific client computer from which a bound encrypted blinded secret was received; and
processing each separate specific received encrypted blinded secret, by the server computer, according to a specific policy corresponding to a specific unique policy id to which the specific encrypted blinded secret is bound;
wherein the server computer processes different separate specific received encrypted blinded secrets differently, according to separate specific policies.

18. The method of claim 17 wherein processing different separate specific received encrypted blinded secrets differently further comprises:
decrypting at least a subset of the separate specific received encrypted blinded secrets, by the server computer;
wherein decrypting a specific received encrypted blinded secret further comprises using a private key of the server computer and a unique policy id to which the specific received encrypted blinded secret is bound, resulting in a specific decrypted blinded secret bound to the specific unique policy id which is not discernable to the server computer.

19. The method of claim 18 further comprising:
transmitting different specific decrypted blinded secrets bound to different specific unique policy ids to different ones of the plurality of client computers, resulting in different ones of the plurality of client computers unblinding received decrypted blinded secrets using unique policy ids to which the received decrypted blinded secrets are bound and unblinding factors corresponding specific onetime use blinding factors, resulting in corresponding secrets in plaintext.

20. The method of claim 18 wherein decrypting a specific encrypted blinded secret using a private key of the server computer and a specific unique policy id further comprises:
decrypting the specific encrypted blinded secret using an RSA decryption function, with an RSA private exponent, the specific unique policy id and an RSA modulus as parameters.
